(19) United States
(12) Patent Application Publication
(10) Pub. No.: US 2025/0153920 A1
(43) Pub. Date: May 15, 2025

(54) MEDIA CONTAINER

(71) Applicant: MARCO Systemanalyse und Entwicklung GmbH, Dachau (DE)

(72) Inventor: Martin REUTER, Dachau (DE)

(21) Appl. No.: 18/938,761

(22) Filed: Nov. 6, 2024

(30) Foreign Application Priority Data
Nov. 13, 2023 (DE) 102023131505.6

(51) Int. Cl. B65D 81/20; B65D 25/10; B65D 43/02; B65D 53/02; B65D 77/04

(52) U.S. Cl. CPC B65D 81/2053; B65D 25/10; B65D 43/0202; B65D 53/02; B65D 77/04; B65D 2543/00092; B65D 2543/00972

(57) ABSTRACT

A media container comprises a pressure vessel that can be closed in a pressure-tight manner with a cover. A media connection, which is attached to a connection ring between the pressure vessel and the cover, is provided for discharging medium from the pressure vessel.

### CROSS-REFERENCE TO RELATED APPLICATIONS

This application claims priority to German Patent Application No. 102023131505.6, filed on Nov. 13, 2023. The entire disclosure of the above application is incorporated herein by reference.

The present invention relates to a media container that comprises a pressure vessel that can be closed in a pressure-tight manner with a cover, wherein a compressed air connection is provided for feeding compressed air into the pressure vessel and a media connection is provided for discharging medium from the pressure vessel.

Such media containers are known from the prior art and serve to store and convey fluid media. Since the medium is stored in a pressure-tight manner in the container, no vapors or gases can escape from the container. The media can be expelled through the media connection by pressurizing the interior of the container.

It is the object of the present invention to provide a media container of the above-described kind that is easier to handle.

This object is satisfied by the features of claim 1 and in particular in that a connection ring is provided which can be mounted in a sealed manner between the pressure vessel and the cover and to which the media connection and optionally also the compressed air connection are attached.

According to the invention, the cover, at whose underside a rising line is usually located, is thus not provided with the media connection, but the latter is located solely at the connection ring. Unhindered access to the interior of the container can therefore take place when filling the container and when removing the cover. If the pressure vessel is filled with medium or an inner container filled with medium is inserted into the pressure vessel, a rising line that is connected to the medium connection can be easily introduced into the medium or introduced into the interior of an inner container and oriented without having to hold the cover in the hand or even having to place it onto the container in so doing. If the connection ring is also provided with a compressed air connection, no further lines need to be connected to the cover that could hinder the placing and handling of the cover. When the cover is removed, unhindered access to the container interior is ensured so that a filling of the pressure vessel with medium, an insertion of an inner container into the pressure vessel or a removal of the inner container from the pressure vessel are facilitated. In particular, a rising line fastened to the underside of the cover does not have to be maneuvered into an often small access opening of an inner container when placing on the cover.

Advantageous embodiments of the invention are described in the description, in the drawing and in the dependent claims.

According to a first advantageous embodiment, a rising line that can be introduced into the pressure vessel can be connected to the media connection and can be guided through the media connection to the outside. According to a further advantageous embodiment, this rising line can be a shape stable hose that can also be easily introduced into a narrow access opening of an inner container and adjusted there. After introduction into an inner container, the hose can thus be oriented so that the lower end of the hose is located at the base of the inner container.

To replace an inner container, the rising line must first be removed from the inner container. To avoid contamination in this respect, it can be advantageous if the rising line is connected to the media connection via a fast-coupling. The rising line can hereby be removed from the media connection in a quick and uncomplicated manner so that the inner container can be removed from the pressure vessel together with the rising line. Subsequently, only the rising line, which may still be provided with dripping medium, has to be changed from the empty inner container to an inner container filled with fresh medium so that the inner container can subsequently be inserted into the pressure vessel. After connecting the rising line to the media connection via the fast-coupling and after adjusting the rising line within the inner container, the cover can be placed onto the connection ring.

According to a further advantageous embodiment, the base of the pressure vessel can have an inclined platform for an inner container. In the simplest case, such an inclined platform can be formed by a wedge or the like, whereby the base of the inner container is set into an inclined position so that the medium collects at a lowest point when almost completely emptying the inner container. If the rising line or the hose has previously been adjusted so that it is located at the lowest point of the inner container, the entire medium can be removed from the inner container when the sealed pressure vessel is pressurized via the compressed air connection.

According to a further advantageous embodiment, a filling level sensor can be arranged in the interior of the pressure vessel at the base of said pressure vessel. Said filling level sensor can, for example, be located at the outer side of an inner container and can detect the filling level capacitively.

According to a further advantageous embodiment, the filling level sensor is integrated into an inclined platform and in particular such that said filling level sensor is located either below the base of the inner container or next to or slightly above the base. In this way, it can particularly easily detected whether the inner container is almost empty.

According to a further advantageous embodiment, the connection ring is provided with a bushing for an electrical cable. The cable of a filling level sensor can hereby be easily guided out of the media container, for example. The bushing can also have a plug-in connection.

According to a further aspect of the present invention, the invention relates to a method for filling a media container of the above-described kind, wherein the connection ring is first placed onto the pressure vessel and an inner container filled with medium is subsequently placed into the pressure vessel. After introducing a rising line into the inner container, said rising line can be oriented such that its lower end contacts the base of the inner container and in particular this point of the inner container. After placing the cover onto the connection ring, the pressure vessel can then be closed in a pressure-tight manner and pressurized for conveying medium.

Before placing on the cover, in particular a filling level sensor can in this respect be adjusted if is located within the pressure vessel. The adjustment can in this respect comprise a mechanical positioning and the setting of a switching point.

The present invention will be described in the following purely by way of example with reference to an advantageous embodiment and to the enclosed drawings. There are shown:

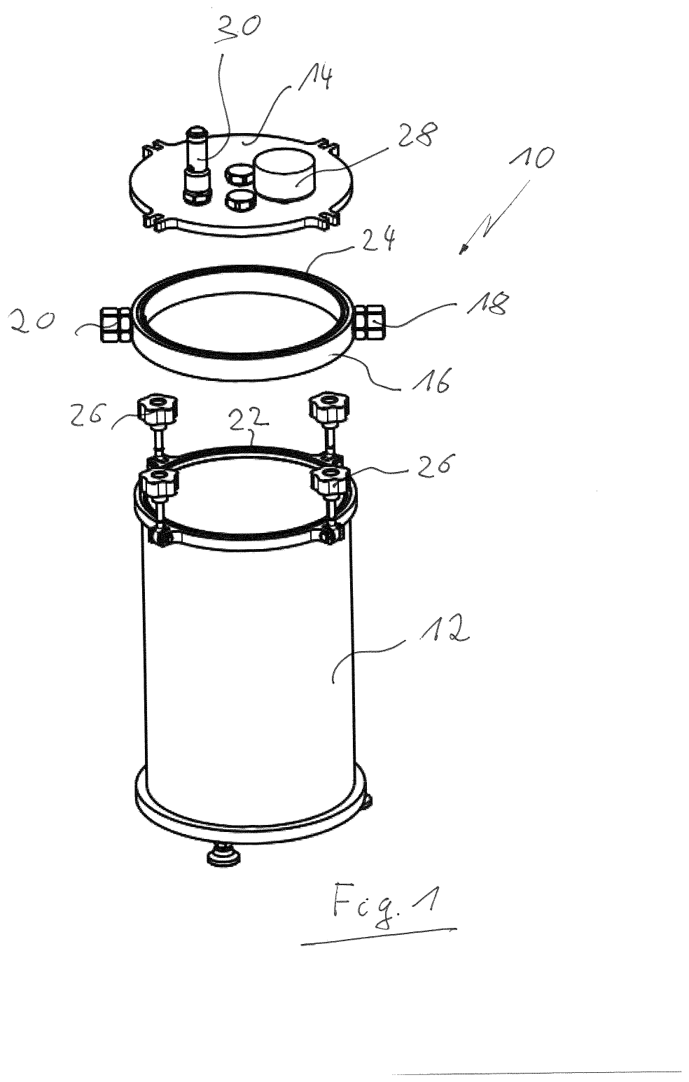

FIG. 1 an exploded view of a media container; and

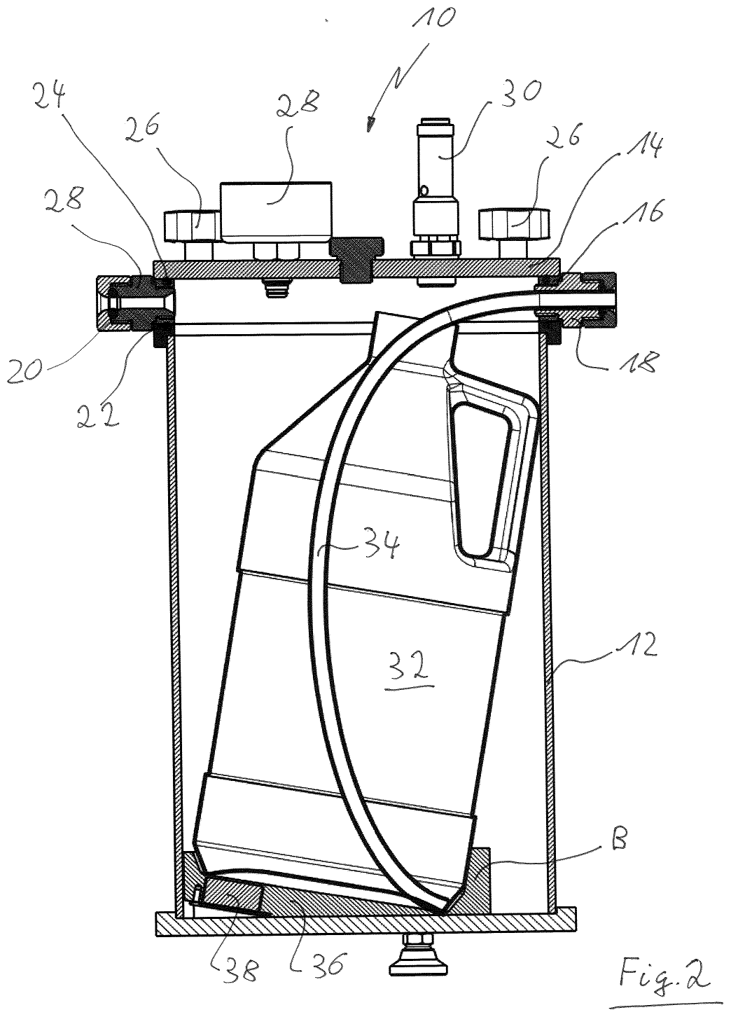

FIG. 2 a sectioned side view of the media container of FIG. 1 with an inner container located therein.

FIG. 1 shows an exploded view of a media container 10 that is of a three-part design and that comprises a pressure vessel 12 that can be closed in a pressure-tight manner with a cover 14. A connection ring 16, which is provided with a media connection 18 and selectively also with a compressed air connection 20, can be mounted in a sealed manner between the pressure vessel 12 and the cover 14.

In the embodiment example shown, the media container 10 is circular-cylindrical so that the connection ring 16 also has the shape of a circular ring. However, it is understood that the cross-sectional shape of the media container and correspondingly also of the connection ring 16 and the cover 14 can be arbitrary. A peripheral seal 22 and 24 is in each case provided between the pressure vessel 12, the connection ring 16 and the cover 14 to be able to seal the media container in a pressure-tight manner. After placing the connection ring 16 onto the pressure vessel 12 and placing the cover 14 onto the connection ring 16, screw bolts 26 attached to the pressure vessel 12 can be folded upwards and clamped to the cover 14.

A manometer 28 and a pressure relief valve 30 can be attached to the cover 14.

FIG. 2 shows a sectional view through the media container 10 of FIG. 1 that is installed in a pressure-tight manner. As can be seen, the media connection 18 and the pressure connection 20 are screwed in the connection ring 16. A connection hose of a pressure source can be connected to the pressure connection 28. A media hose can be connected to the media connection 18 and transports the medium conveyed out of the media container to a desired location.

As FIG. 2 furthermore illustrates, an inner container 32, into whose interior a rising line in the form of a shape stable hose 34 is introduced, is inserted in the pressure vessel 12. In this respect, the hose is adjusted and oriented so that its lower end is located at the lowest point of the inner container 32. The upper end of the rising hose 34 is coupled to the media connection 18, wherein this coupling can take place via a fast-coupling.

Furthermore, it can be seen from FIG. 2 that the base of the pressure vessel 12 has an inclined platform 36 that is in particular adapted to the shape of the inner container 32 and that sets the inner container 32 into a slightly inclined position. Furthermore, in the embodiment shown, a filling level sensor 38 is present that, in the embodiment example shown, is integrated into the inclined platform 36 and is located below the base of the inner container 32. This filling level sensor 38 can be configured as a capacitive sensor. It can hereby be detected with high resolution when the level of the medium within the inner container 32 has approached the filling level sensor 38 and continues to drop. If the medium conveyed out of the inner container 32 is fed to a metering apparatus, it can then also be calculated, by detecting the total quantity metered, how many cans can still be metered until the inner container 32 is completely emptied.

Alternatively, the filling level sensor 38 can also be arranged in a region B and can be integrated there, for example, into the inclined platform 36.

The connection ring 16 can be provided with a bushing, not shown in the Figures, for an electrical cable of the filling level sensor 38. The bushing can be designed as a pressure-tight bushing and can optionally also have an electrical plug-in connection so that an electrical connection line can be plugged onto the outer side of the connection ring.

When filling the media container for the first time or when changing the media container 32, the cover 14 can be completely removed from the pressure vessel 12 after loosening the screw bolts 26 without having to consider lines, pipes or hose connections, which may contain dripping medium, in this respect. Completely free access to the interior of the pressure vessel 12 is then possible so that the rising hose 34 can be pulled out of the comparatively small opening of the inner container 32 so that the empty inner container 32 can be replaced with an inner container filled with medium. If the upper end of the rising hose 34 is connected to the media connection 18 via a fast-coupling, the unit comprising the inner container 32 and rising hose 34 can be removed from the pressure vessel 12.

After inserting a filled inner container 32 and adjusting the rising hose 34, a filling level sensor 38 can subsequently still be adjusted if necessary. The cover 14 can then be placed onto the upper side of the connection ring 16 and can be screwed to the pressure vessel 12 in a pressure-tight manner again. By applying compressed air to the pressure connection 20, medium can subsequently be conveyed from the inner container 32 through the rising hose 34 out of the media connection 18.

It is naturally also possible to fill an empty inner container 32 with fresh medium when the cover 14 is open without having to remove the rising hose 34 or a rising line from the inner container in so doing.

1. A media container, comprising a pressure vessel that can be closed in a pressure-tight manner with a cover, wherein a compressed air connection is provided for feeding compressed air into the pressure vessel and a media connection is provided for discharging medium from the pressure vessel, the media container further comprising
a connection ring which can be mounted in a sealed manner between the pressure vessel and the cover and to which the media connection is attached.

2. The media container according to claim 1,
wherein the compressed air connection is also attached to the connection ring.

3. The media container according to claim 1,
wherein a rising line that can be introduced into the pressure vessel is connected to the media connection.

4. The media container according to claim 3,
wherein the rinsing line is a shape stable hose.

5. The media container according to claim 3,
wherein the rising line is connected to the media connection via a fast-coupling.

6. The media container according to claim 1,
wherein the base of the pressure vessel has an inclined platform for an inner container.

7. The media container according to claim 1,
wherein an inner container is located in the interior of the pressure vessel.

8. The media container according to claim 1,
wherein the cover does not have a line projecting into the interior of the pressure vessel.

9. The media container according to claim 1,
wherein a filling level sensor is arranged in the interior of the pressure vessel at the base of said pressure vessel.

10. A media container according to claim 9,
wherein the base of the pressure vessel has an inclined platform for an inner container and the filling level sensor is integrated into the inclined platform.

11. A media container according to claim 10,
wherein the filling level sensor is located in the region of the base and/or below the base of an inner container.

12. The media container according to claim 1,
wherein the connection ring is provided with a bushing for an electrical cable.

13. A method for filling a media container, the media container comprising a pressure vessel that can be closed in a pressure-tight manner with a cover, wherein a compressed air connection is provided for feeding compressed air into the pressure vessel and a media connection is provided for discharging medium from the pressure vessel,
the media container further comprising
a connection ring which can be mounted in a sealed manner between the pressure vessel and the cover and to which the media connection is attached,
the method comprising the following steps:
placing the connection ring onto the pressure vessel,
inserting an inner container filled with medium into the pressure vessel,
introducing a rising line into the inner container,
orienting the rising line such that its lower end contacts the base of the inner container,
placing the cover onto the connection ring, and
closing the pressure vessel in a pressure-tight manner.

14. The method according to claim 13,
wherein a filling level sensor is provided in the interior of the pressure vessel.

15. The method according to claim 14,
further comprising the step of:—before the placing on of the cover—adjusting the filling level sensor.
